(19) United States
(12) Patent Application Publication
(10) Pub. No.: US 2022/0394950 A1
(43) Pub. Date: Dec. 15, 2022

(54) FOLDABLE PET CAGE

(71) Applicant: Zhongshan Ekar Uping Houseware Co., Ltd., Zhongshan City (CN)

(72) Inventors: Jianghua HE, Zhongshan City (CN); Guozhu FENG, Zhongshan City (CN); Xinliang OUYANG, Zhongshan City (CN)

(21) Appl. No.: 17/393,638

(22) Filed: Aug. 4, 2021

(30) Foreign Application Priority Data
Jun. 15, 2021 (CN) 202121327480.4

(51) Int. Cl. A01K 1/02

(52) U.S. Cl. CPC A01K 1/0245

(57) ABSTRACT

Disclosed is a foldable pet cage, including a frame operable in unfolded and folded states. The frame includes at least two supporting rod assemblies, the supporting rod assemblies are each formed by movably connecting a vertical rod, an upper connecting rod and a lower connecting rod. All the upper connecting rods are rotatably connected with an upper connecting seat, and a first locking structure is arranged between the upper connecting seat and the upper connecting rod. All the lower connecting rods are rotatably connected with a lower connecting seat, and a second locking structure is arranged between the lower connecting seat and the lower connecting rod.

### CROSS-REFERENCE TO RELATED APPLICATIONS

This application is based on and claims the benefit of priority from Chinese Patent Application No. 2021213274804, filed on 15 Jun. 2021, the entirety of which is incorporated by reference herein.

### TECHNICAL FIELD

The disclosure relates to the field of pets, and more particularly, to a foldable pet cage.

### BACKGROUND

With the improvement of living standards, more and more people like keeping a pet, such as a kitty and a puppy. In order to prevent the pet from running around indoors and contaminating the indoor environment, people now generally use a pet cage to confine the pet.

Existing pet cage for keeping the pet generally includes a frame and a cloth cover arranged on a periphery of the frame. Although the structure is simple and firm, the frame occupies a large space, which is inconvenient to store, transport and use.

### SUMMARY

The disclosure aims to solve at least one of the technical problems in the existing technology. For this purpose, the disclosure provides a foldable pet cage, and a volume of the pet cage can be reduced when the pet cage is not used, so as to facilitate storage or transportation of the pet cage.

The following technical solutions are used in the disclosure to solve the above technical problems.

The foldable pet cage according to some embodiments of the disclosure includes a frame operable in unfolded and folded states, wherein the frame includes: at least two supporting rod assemblies, wherein each of the supporting rod assemblies includes a vertical rod, an upper connecting rod and a lower connecting rod, one end of the upper connecting rod is rotatably connected with an upper portion of the vertical rod, and one end of the lower connecting rod is rotatably connected with a lower portion of the vertical rod; an upper connecting seat, wherein ends of all the upper connecting rods far away from the vertical rods are rotatably connected with the upper connecting seat, and a first locking structure is arranged between the upper connecting seat and the upper connecting rod to limit relative rotation of the upper connecting seat and the upper connecting rod; and a lower connecting seat, wherein ends of all the lower connecting rods far away from the vertical rods are rotatably connected with the lower connecting seat, and a second locking structure is arranged between the lower connecting seat and the lower connecting rod to limit relative rotation of the lower connecting seat and the lower connecting rod.

In some embodiments of the disclosure, all the supporting rod assemblies are uniformly distributed around a circumferential direction of the upper connecting seat or the lower connecting seat.

In some embodiments of the disclosure, the upper connecting rod has a same length as the lower connecting rod.

In some embodiments of the disclosure, the first locking structure includes a first inserting hole and a first pin which are matched and clamped with each other, the first pin is movably mounted on the upper connecting seat or the upper connecting rod, and the first inserting hole is correspondingly arranged in the upper connecting rod or the upper connecting seat; wherein, the first pin is insertable into the first inserting hole or is withdrawable from the first inserting hole.

In some embodiments of the disclosure, the first pin is movably mounted at one end of the upper connecting rod close to the upper connecting seat, and the first inserting holes are distributed around a periphery of the upper connecting seat; and a middle portion of the upper connecting seat is provided with a first communication cavity communicated with all the first inserting holes, a first rotating member is rotatably mounted in the first communication cavity, at least two first guiding blocks are arranged on a periphery of the first rotating member, and the first guiding block is capable of driving the first pin to withdraw from the first inserting hole.

In some embodiments of the disclosure, the upper connecting rod is internally provided with a first elastic driving member contacted with the first pin, and the first elastic driving member is capable of driving the first pin to move along an axial direction of the upper connecting rod and move away from the vertical rod.

In some embodiments of the disclosure, the second locking structure includes a second inserting hole and a second pin which are capable of being matched and clamped with each other, the second pin is movably mounted on the lower connecting seat or the lower connecting rod, and the second inserting hole is correspondingly arranged in the lower connecting rod or the lower connecting seat; wherein, the second pin is insertable into the second inserting hole or is withdrawable from the second inserting hole.

In some embodiments of the disclosure, the second pin is movably mounted at one end of the lower connecting rod close to the lower connecting seat, and the second inserting holes are distributed around a periphery of the lower connecting seat; and a middle portion of the lower connecting seat is provided with a second communication cavity communicated with all the second inserting holes, a second rotating member is rotatably mounted in the second communication cavity, at least two second guiding blocks are arranged on a periphery of the second rotating member, and the second guiding block is capable of driving the second pin to withdraw from the second inserting hole.

In some embodiments of the disclosure, the pet cage further includes a flexible air-permeable bag capable of retracting or extending, wherein the flexible air-permeable bag is sleeved on the periphery of the frame.

In some embodiments of the disclosure, the flexible air-permeable bag is a cloth cover.

The pet cage according to some embodiments of the disclosure has the beneficial effects as follows. By using the above structure, after the frame is unfolded, the first locking structure limits relative rotation of the upper connecting seat and the upper connecting rod, and the second locking structure limits relative rotation of the low connecting seat and the lower connecting rod, so that the frame is kept in an unfolded state, and at the moment, the pet cage can be used for confining a pet. When the pet cage is not needed, the first locking structure may release the relative rotation of the upper connecting seat and the upper connecting rod, the second locking structure may release the relative rotation of the lower connecting seat and the lower connecting rod, and then the pet cage can be folded, thus greatly reducing a volume of the pet cage, facilitating transportation or storage, and meeting needs of a user.

### BRIEF DESCRIPTION OF THE DRAWINGS

The disclosure is further described in detail hereinafter with reference to the accompanying drawings and the specific embodiments.

FIG. 1 is a schematic diagram of an appearance when a pet cage is in an unfolded state according to some embodiments of the disclosure;

FIG. 2 is a schematic diagram of an appearance when the pet cage shown in FIG. 1 is in a folded state;

FIG. 3 is an exploded view of a local structure when the pet cage shown in FIG. 1 is in an unfolded state;

FIG. 4 is a cross-sectional view of an internal structure when the pet cage shown in FIG. 1 in an unfolded state;

FIG. 5 is a cross-sectional view of an internal structure when the pet cage shown in FIG. 1 in an unfolded state and a first locking structure is in an unlocked state;

FIG. 6 is an enlarged view of a part A in FIG. 4;

FIG. 7 is an enlarged view of a part B in FIG. 5; and

FIG. 8 is an enlarged view of a part C in FIG. 4.

### DETAILED DESCRIPTION

This part will describe the specific embodiments of the disclosure in detail, and the preferred embodiments of the disclosure are shown in the accompanying drawings. The accompanying drawings are used to supplement the description of the text in the specification with the graphs, so that people can intuitively and vividly understand each technical feature and the overall technical solution of the disclosure, but the accompanying drawings cannot be understood as limiting the scope of protection of the disclosure.

In the description of the disclosure, it should be understood that the orientation or position relationship indicated by the terms up, down, front, rear, left, right, and the like is based on the orientation or position relationship shown in the accompanying drawings, it is only for the convenience of description of the disclosure and simplification of the description, and it is not to indicate or imply that the indicated device or element must have a specific orientation, and be constructed and operated in a specific orientation. Therefore, the terms shall not be understood as limiting the disclosure.

In the description of the present disclosure, the meaning of “several” is one or more, the meaning of “a plurality of” is two or more, “greater than”, “less than”, “more than”, etc. are to be understood to exclude the given figure, and “above”, “below”, “within”, etc. are understood to include the given figure. If “first” and “second”, etc. are referred to, it is only for the purpose of distinguishing technical features, and shall not be understood as indicating or implying relative importance or implying the number of the indicated technical features or implying the sequence of the indicated technical features.

In the description of the present disclosure, unless otherwise explicitly defined, the words such as “set”, “install”, and “connect” should be understood in a broad sense, and those skilled in the art can determine the specific meanings of the above words in the present disclosure in a rational way in combination with the specific contents of the technical solutions.

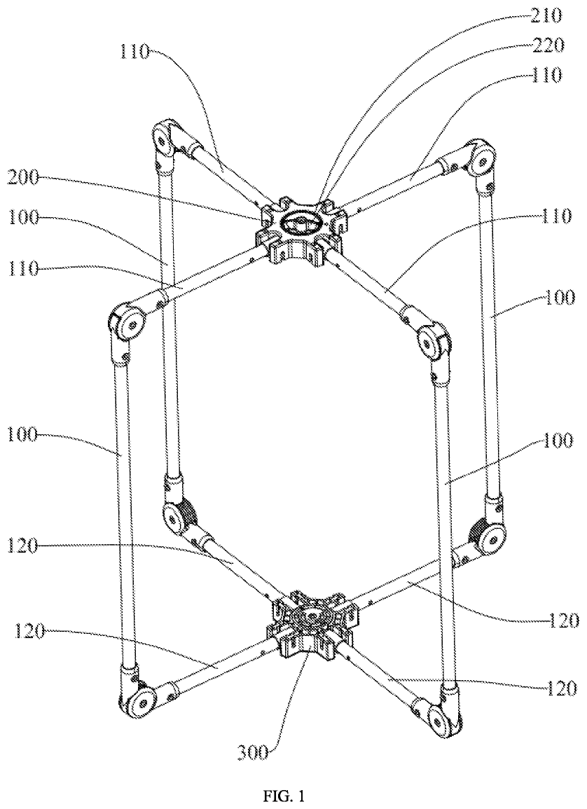

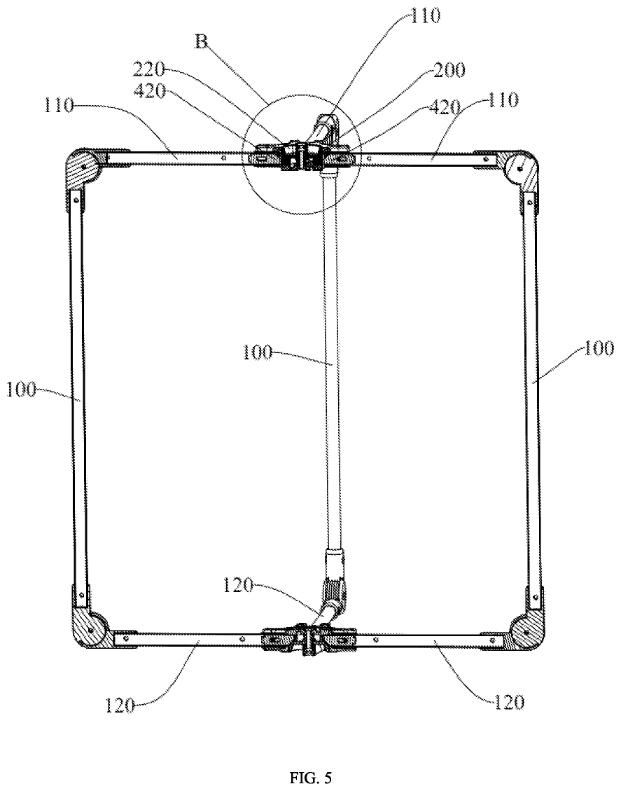

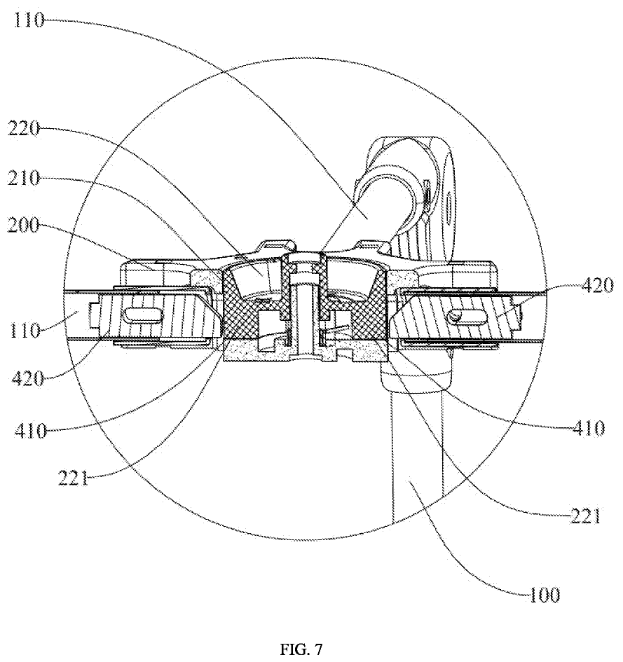

With reference to FIG. 1 to FIG. 8, a foldable pet cage according to some embodiments of the disclosure includes a frame operable in unfolded and folded states. The frame includes at least two supporting rod assemblies, an upper connecting seat 200 and a lower connecting seat 300. In the embodiment, four supporting rod assemblies are provided, and it is conceivable that two, three, five, six or more supporting rod assemblies may be provided, which may specifically be determined according to actual needs.

The supporting rod assembly includes a vertical rod 100, an upper connecting rod 110 and a lower connecting rod 120, one end of the upper connecting rod 110 is rotatably connected with an upper portion of the vertical rod 100, and one end of the lower connecting rod 120 is rotatably connected with a lower portion of the vertical rod 100. Ends of all the upper connecting rods 110 far away from the vertical rods 100 are rotatably connected with the upper connecting seat 200. In the embodiment, ends of the upper connecting rods 110 far away from the vertical rods 100 are rotatably connected with the upper connecting seat 200 through a pivot (not shown in the drawings). A first locking structure is arranged between the upper connecting seat 200 and the upper connecting rod 110 to limit relative rotation of the upper connecting seat and the upper connecting rod. Ends of all the lower connecting rods 120 far away from the vertical rods 100 are rotatably connected with the lower connecting seat 300. In the embodiment, ends of the lower connecting rods 120 far away from the vertical rods 100 are rotatably connected with the lower connecting seat 300 through a pivot (not shown in the drawings). A second locking structure is arranged between the lower connecting seat 300 and the lower connecting rod 120 to limit relative rotation of the lower connecting seat and the lower connecting rod.

By using the above structure, after the frame is unfolded, the first locking structure limits the relative rotation of the upper connecting seat 200 and the upper connecting rod 110, and the second locking structure limits the relative rotation of the low connecting seat 300 and the lower connecting rod 120, so that the frame is kept in an unfolded state. In this case, the pet cage may be used for confining a pet. When the pet cage is not needed, the first locking structure may release the relative rotation of the upper connecting seat 200 and the upper connecting rod 110, the second locking structure may release the relative rotation of the lower connecting seat 300 and the lower connecting rod 110, and then the pet cage can be folded, thus greatly reducing a volume of the pet cage, facilitating transportation or storage, and meeting needs of a user.

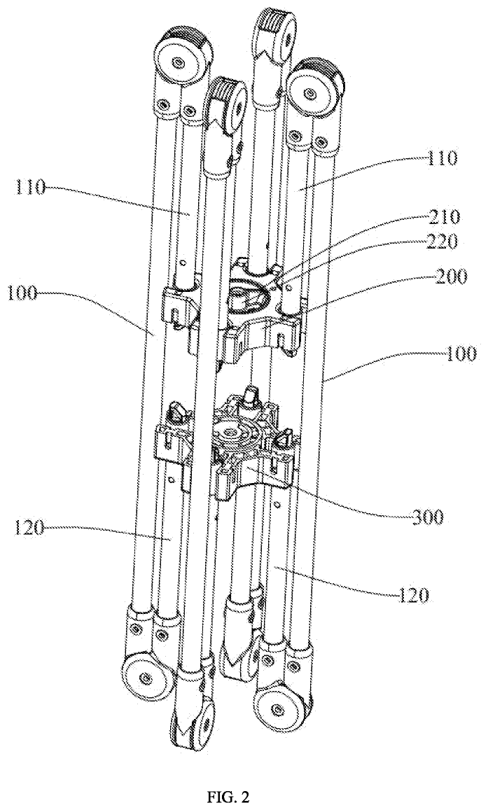

With reference to FIG. 1 and FIG. 2, in order to enable the frame firmer in structure, in some embodiments of the disclosure, all the supporting rod assemblies are uniformly distributed around a circumferential direction of the upper connecting seat 200 or the lower connecting seat 300. By using the above structure, all the supporting rod assemblies can be better connected with the upper connecting seat 200 or the lower connecting seat 300, so that the frame has more uniform stress and firmer structure.

Further, in order to use the frame more conveniently, in some embodiments of the disclosure, a length of the upper connecting rod 110 is the same as that of the lower connecting rod 120. Therefore, the frame may be placed upside down, thus being used more conveniently.

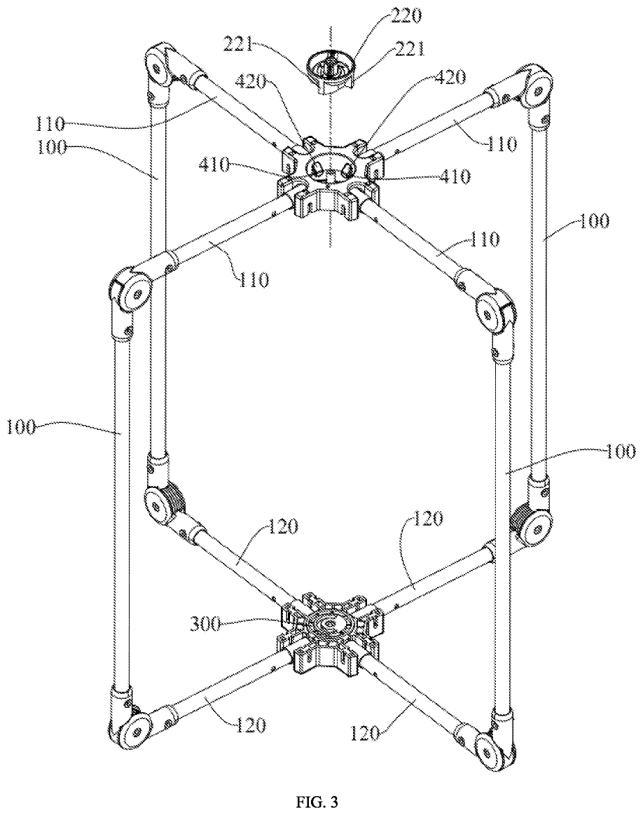

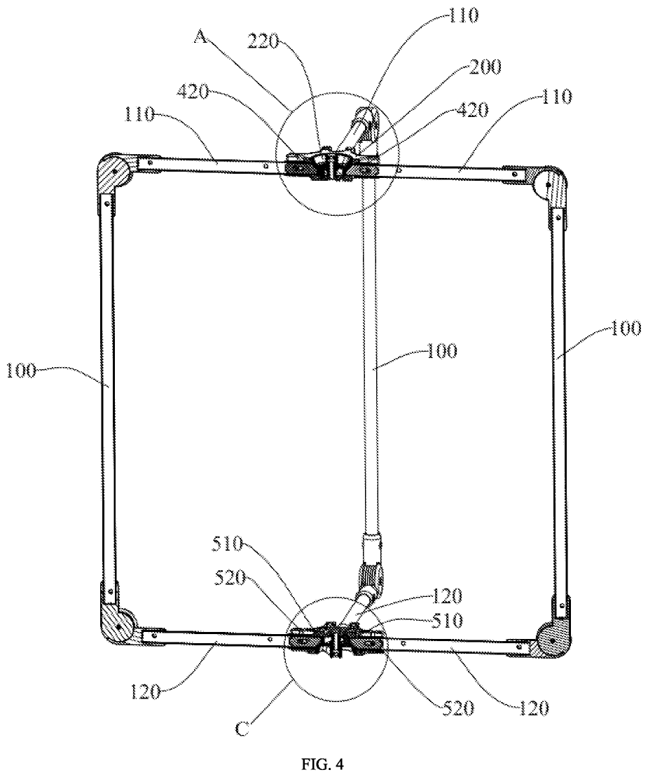

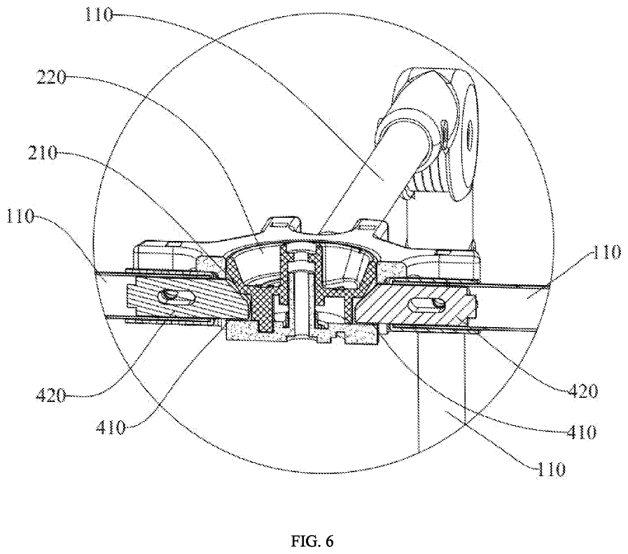

With reference to FIG. 3, FIG. 4 and FIG. 6, in order to make a structure of the first locking structure simpler, in some embodiments of the disclosure, the first locking structure includes a first inserting hole 410 and a first pin 420 which are matched and clamped with each other, the first pin 420 is movably mounted on the upper connecting seat 200 or the upper connecting rod 110, and the first inserting hole 410 is correspondingly arranged in the upper connecting rod 110 or the upper connecting seat 200. The first pin 420 is insertable into the first inserting hole 410 or is withdrawable from the first inserting hole 410.

With reference to FIG. 3 to FIG. 7, in some embodiments of the disclosure, the first pin 420 is movably mounted at one end of the upper connecting rod 110 close to the upper connecting seat 200, and the first inserting holes 410 are distributed around a periphery of the upper connecting seat 200. A middle portion of the upper connecting seat 200 is provided with a first communication cavity 210 communicated with all the first inserting holes 410, a first rotating member 220 is rotatably mounted in the first communication cavity 210, at least two first guiding blocks 221 are arranged on a periphery of the first rotating member 220, a number of the first guiding blocks 221 is consistent with a number of the first pins 420, the first guiding blocks 221 are paired with the first pins 420 in one-to-one correspondence for use, and the first guiding block 221 can drive the first pin 420 to withdraw from the first inserting hole 410.

When the user unfolds the frame, the user drives the upper connecting rod 110 to rotate relative to the upper connecting seat 200, so that the first pin 420 is aligned with the first inserting hole 410. At the moment, the first pin 420 is correspondingly inserted into the first inserting hole 410, so that the first locking structure locks a relative position between the upper connecting rod 110 and the upper connecting seat 200, thus limiting the upper connecting rod 110 from rotating relative to the upper connecting seat 200. When the user needs to fold the pet cage, the user may rotate the first rotating member 220. During rotation of the first rotating member 220, the first guiding block 221 may be contacted with the first pin 420 and drive the first pin 420 to withdraw from the first inserting hole 410. At the moment, the first locking structure releases locking of the upper connecting rod 110 and the upper connecting seat 200, and then the upper connecting rod 110 may be rotated and folded relative to the upper connecting seat 200, thus achieving the purpose of folding the pet cage.

It can be understood that the first locking structure may also use other structures besides the above structure. For example, the first locking structure may include an upper connecting seat locking hole (not shown in the drawings) formed in the upper connecting seat 200, an upper connecting rod locking hole (not shown in the drawings) formed in the upper connecting rod 110, and an upper locking pin (not shown in the drawings). When the upper connecting rod 110 rotates until the upper connecting rod locking hole is overlapped with the upper connecting seat locking hole, the user may correspondingly insert the upper locking pin into the upper connecting rod locking hole and the upper connecting seat locking hole, thus locking the relative position between the upper connecting seat 200 and the upper connecting rod 110. When the upper connecting rod 110 needs to be rotated, the user only needs to pull out the upper locking pin, which is simple and convenient.

In order to automatically insert the first pin 420 into the first inserting hole 410, in some embodiments of the disclosure, the upper connecting rod 110 is internally provided with a first elastic driving member (not shown in the drawings) contacted with the first pin 420, and the first elastic driving member can drive the first pin 420 to move along an axial direction of the upper connecting rod 110 and move away from the vertical rod 100. Specifically, the first elastic driving member may be a compression spring (not shown in the drawings), one end of the compression spring abuts against an inner wall of the upper connecting rod 110, and the other end of the compression spring abuts against the first pin 420, and the compression spring continuously applies an elastic force on the first pin 420. When the first pin 420 is aligned with the first inserting hole 410, the first pin 420 can be automatically inserted into the first inserting hole 410 under an elastic force of the compression spring to automatically lock the first locking structure.

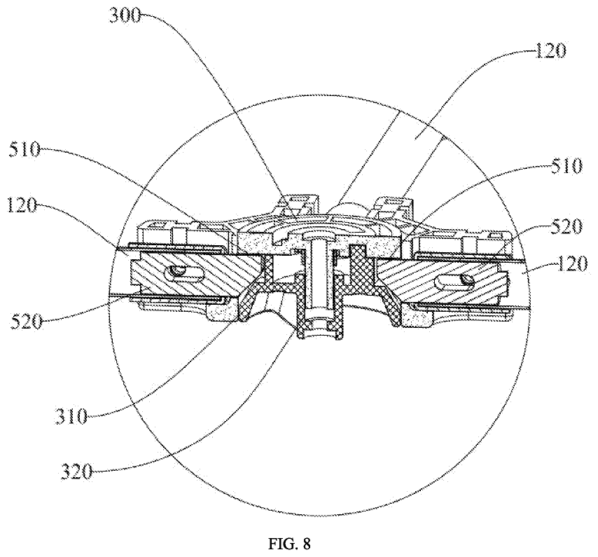

With reference to FIG. 4 and FIG. 8, in order to make a structure of the second locking structure more compact and simpler, in some embodiments of the disclosure, the second locking structure includes a second inserting hole 510 and a second pin 520 which are matched and clamped with each other, the second pin 520 is movably mounted on the lower connecting seat 300 or the lower connecting rod 120, and the second inserting hole 510 is correspondingly arranged in the lower connecting rod 120 or the lower connecting seat 300. The second pin 520 is insertable into the second inserting hole 510 or is withdrawable from the second inserting hole 510.

Specifically, the second pin 520 is movably mounted at one end of the lower connecting rod 120 close to the lower connecting seat 300, and the second inserting holes 510 are distributed around a periphery of the lower connecting seat 300. A middle portion of the lower connecting seat 300 is provided with a second communication cavity 310 communicated with all the second inserting holes 510, a second rotating member 320 is rotatably mounted in the second communication cavity 310, at least two second guiding blocks (not shown in the drawings) are arranged on a periphery of the second rotating member 320, a number of the second guiding blocks is consistent with a number of the second pins 520, and the second guiding blocks are paired with the second pins 520 in one-to-one correspondence for use. The second guiding block can drive the second pin 520 to withdraw from the second inserting hole 510.

When the user unfolds the frame, the user drives the lower connecting rod 120 to rotate relative to the lower connecting seat 300, so that the second pin 520 is aligned with the second inserting hole 510. At the moment, the second pin 520 is correspondingly inserted into the second inserting hole 510, so that the second locking structure locks a relative position between the lower connecting rod 120 and the lower connecting seat 300, thus limiting the lower connecting rod 120 from rotating relative to the lower connecting seat 300. When the user needs to fold the pet cage, the user may rotate the second rotating member 320. During rotation of the second rotating member 320, the second guiding block may be contacted with the second pin 520 and drive the second pin 520 to withdraw from the second inserting hole 510. At the moment, the second locking structure releases locking of the lower connecting rod 120 and the lower connecting seat 300, and then the lower connecting rod 120 can be rotated and folded relative to the lower connecting seat 300, thus achieving the purpose of folding the pet cage.

It can be understood that the second locking structure may also use other structures besides the above structure. For example, the second locking structure includes a lower connecting seat locking hole (not shown in the drawings) formed in the lower connecting seat 300, a lower connecting rod locking hole (not shown in the drawings) formed in the lower connecting rod 120, and a lower locking pin (not shown in the drawings). When the lower connecting rod 120 rotates until the lower connecting rod locking hole is overlapped with the lower connecting seat locking hole, the user may correspondingly insert the lower locking pin into the lower connecting rod locking hole and the lower connecting seat locking hole, thus locking the relative position between the lower connecting seat 300 and the lower connecting rod 120. When the lower connecting rod 120 needs to be rotated, the user only needs to pull out the lower locking pin, which is simple and convenient. Since the second locking structure is consistent with the first locking structure, the details will not be repeated herein.

Further, in order to enable the pet cage keep the pet better, in some embodiments of the disclosure, the pet cage further includes a flexible air-permeable bag capable of retracting or extending. The flexible air-permeable bag is sleeved on the periphery of the frame. Specifically, the flexible air-permeable bag is a cloth cover, and it is conceivable that the flexible air-permeable bag may also be a mesh bag with a porous structure, etc., which is specifically determined according to actual needs.

The embodiments of the disclosure are described in detail with reference to the accompanying drawings above, but the disclosure is not limited to the above embodiments, and various changes may also be made within the knowledge scope of those of ordinary skills in the art without departing from the purpose of the disclosure.

What is claimed is:

1. A foldable pet cage, comprising a frame operable in unfolded and folded states, wherein the frame comprises:
at least two supporting rod assemblies, wherein each of the supporting rod assemblies comprises a vertical rod, an upper connecting rod and a lower connecting rod, one end of the upper connecting rod is rotatably connected with an upper portion of the vertical rod, and one end of the lower connecting rod is rotatably connected with a lower portion of the vertical rod;
an upper connecting seat, wherein ends of all the upper connecting rods far away from the vertical rods are rotatably connected with the upper connecting seat, and a first locking structure is arranged between the upper connecting seat and the upper connecting rod to limit relative rotation of the upper connecting seat and the upper connecting rod; and
a lower connecting seat, wherein ends of all the lower connecting rods far away from the vertical rods are rotatably connected with the lower connecting seat, and a second locking structure is arranged between the lower connecting seat and the lower connecting rod to limit relative rotation of the lower connecting seat and the lower connecting rod.

2. The foldable pet cage of claim 1, wherein,
all the supporting rod assemblies are uniformly distributed around a circumferential direction of the upper connecting seat or the lower connecting seat.

3. The foldable pet cage of claim 1, wherein,
the upper connecting rod has a same length as the lower connecting rod.

4. The foldable pet cage of claim 1, wherein,
the first locking structure comprises a first inserting hole and a first pin which are matched and clamped with each other,
the first pin is movably mounted on the upper connecting seat or the upper connecting rod, and the first inserting hole is correspondingly arranged in the upper connecting rod or the upper connecting seat;
wherein, the first pin is insertable into the first inserting hole or is withdrawable from the first inserting hole.

5. The foldable pet cage of claim 4, wherein,
the first pin is movably mounted at one end of the upper connecting rod close to the upper connecting seat, and the first inserting holes are distributed around a periphery of the upper connecting seat; and
a middle portion of the upper connecting seat is provided with a first communication cavity communicated with all the first inserting holes, a first rotating member is rotatably mounted in the first communication cavity, at least two first guiding blocks are arranged on a periphery of the first rotating member, and the first guiding block is capable of driving the first pin to withdraw from the first inserting hole.

6. The foldable pet cage of claim 5, wherein,
the upper connecting rod is internally provided with a first elastic driving member contacted with the first pin, and the first elastic driving member is capable of driving the first pin to move along an axial direction of the upper connecting rod and move away from the vertical rod.

7. The foldable pet cage of claim 1, wherein,
the second locking structure comprises a second inserting hole and a second pin which are capable of being matched and clamped with each other,
the second pin is movably mounted on the lower connecting seat or the lower connecting rod, and the second inserting hole is correspondingly arranged in the lower connecting rod or the lower connecting seat;
wherein, the second pin is insertable into the second inserting hole or is withdrawable from the second inserting hole.

8. The foldable pet cage of claim 7, wherein,
the second pin is movably mounted at one end of the lower connecting rod close to the lower connecting seat, and the second inserting holes are distributed around a periphery of the lower connecting seat; and
a middle portion of the lower connecting seat is provided with a second communication cavity communicated with all the second inserting holes, a second rotating member is rotatably mounted in the second communication cavity, at least two second guiding blocks are arranged on a periphery of the second rotating member, and the second guiding block is capable of driving the second pin to withdraw from the second inserting hole.

9. The foldable pet cage of claim 1,
further comprising a flexible air-permeable bag capable of retracting or extending, wherein the flexible air-permeable bag is configured to sleeve on the periphery of the frame.

10. The foldable pet cage of claim 9,
the flexible air-permeable bag is a cloth cover.
